(19) United States
(12) Patent Application Publication
(10) Pub. No.: US 2026/0298731 A1
(43) Pub. Date: Oct. 1, 2026

(54) FLAVORED THERMOMETER COVER DEVICE

(71) Applicant: Vicki Coats, Bessemer, AL (US)

(72) Inventor: Vicki Coats, Bessemer, AL (US)

(21) Appl. No.: 19/572,336

(22) Filed: Mar. 19, 2026

Related U.S. Application Data
(60) Provisional application No. 63/780,610, filed on Mar. 31, 2025.

(51) Int. Cl. G01K 13/25

(52) U.S. Cl. CPC G01K 13/25

(57) ABSTRACT

The device is comprised of a flavored thermometer cover device configured to facilitate oral temperature measurement procedures while improving patient cooperation and comfort during medical assessment procedures. The flavored thermometer cover device comprises a body formed from medical-grade material. The body defines a generally tubular sheath sized to receive a thermometer stem through a longitudinal opening along a central axis while allowing the sensing tip to extend beyond a distal portion for direct temperature sensing. A retention feature within the opening may maintain alignment between the body and the thermometer stem. The body further comprises a flavoring incorporated within the material or applied as a coating on an exterior surface, wherein the flavoring releases a detectable taste upon contact with saliva. In some embodiments, the flavoring is incorporated within raised indicia or surface textures that enhance tactile and visual engagement during placement in the mouth.

### CROSS-REFERENCE TO RELATED APPLICATION

The present application claims priority to, and the benefit of, U.S. Provisional Application No. 63/780,610, which was filed on Mar. 31, 2025, and is incorporated herein by reference in its entirety.

### FIELD OF THE INVENTION

The present invention relates generally to the field of thermometer covers. More specifically, the present invention relates to a disposable sanitary cover that fits over a thermometer stem while allowing the sensing tip to remain exposed for accurate oral temperature measurement, and wherein the device releases a pleasant flavor upon contact with saliva. Accordingly, the present disclosure makes specific reference thereto. Nonetheless, it is to be appreciated that aspects of the present invention are also equally applicable to other like applications, devices, and methods of manufacture.

### BACKGROUND

Accurate measurement of body temperature is an important part of medical evaluation, particularly when assessing infants and young children. Healthcare providers and caregivers further often rely on oral thermometers to obtain reliable temperature readings. Oral temperature measurement requires a thermometer probe to remain positioned under the tongue for a short period of time. However, many children struggle to remain still long enough for the thermometer to register a stable reading. Some children may further remove the thermometer prematurely due to discomfort, curiosity, or fear of medical devices. Resistance during the procedure can result in inaccurate temperature measurements and may require multiple attempts. Repeated attempts may increase stress for both the caregiver and the patient. In clinical environments such as pediatric offices, hospitals, and urgent care facilities, delays in obtaining accurate vital signs can interfere with efficient patient assessment. As a result, there remains a need for a device that maintains hygiene while also promoting patient compliance during oral temperature measurement procedures.

Therefore, there exists a long-felt need in the art for a device that encourages children and other patients to keep a thermometer probe under the tongue long enough to obtain an accurate body temperature reading. There also exists a long-felt need in the art for a flavored thermometer cover device that releases a pleasant flavor upon contact with saliva to provide sensory distraction during temperature measurement procedures. Moreover, there exists a long-felt need in the art for a flavored thermometer cover device that maintains a sanitary barrier between a thermometer and a patient while improving patient comfort and cooperation.

The subject matter disclosed and claimed herein, in one embodiment thereof, comprises a flavored thermometer cover device. The device is comprised of a flavored thermometer cover device configured to facilitate oral temperature measurement procedures while improving patient cooperation and comfort during medical assessment procedures. The flavored thermometer cover device comprises a body formed from medical-grade material. The body defines a generally tubular sheath structure sized to receive a stem of a thermometer through a longitudinal through opening extending along a central longitudinal axis. The through opening receives the thermometer stem while permitting a sensing tip of the thermometer to extend beyond a distal portion of the body for direct temperature sensing. The body may further comprise a retention feature positioned within the through opening and configured to maintain alignment of the body relative to the thermometer stem. The body further comprises an incorporated flavoring distributed within the material of the body or applied as a coating along an exterior surface, wherein the flavoring releases a detectable taste upon contact with saliva during oral temperature measurement procedures. In one embodiment, the flavoring may be incorporated within raised indicia positioned along the exterior surface of the body. The raised indicia and surface textures may further enhance tactile and visual engagement during placement of the thermometer within a mouth.

In this manner, the flavored thermometer cover device of the present invention accomplishes all the foregoing objectives and provides a device that functions as a sanitary barrier for a thermometer while simultaneously improving patient cooperation during oral temperature measurement procedures. More specifically, the flavored surface encourages children and other patients to keep the thermometer probe properly positioned under the tongue for a sufficient duration to obtain an accurate reading. The incorporated flavoring and raised indicia may further provide sensory distraction and engagement that reduces fear and resistance commonly associated with medical instruments. The structural configuration of the body and retention features securely interface with the thermometer while allowing the sensing tip to remain exposed for accurate temperature detection. Accordingly, the device improves the efficiency of temperature measurement procedures while enhancing comfort, hygiene, and patient cooperation in medical environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flavored thermometer cover device. The device is a disposable cover configured to facilitate temperature measurement procedures while improving patient cooperation and comfort. More specifically, the device interfaces with a thermometer during oral temperature measurement and incorporates a flavoring that provides sensory distraction during temperature measurement procedures, thereby encouraging proper placement of the thermometer and reducing patient resistance.

The device is comprised of a body made from a medical-grade material. The body is configured as a tubular or sheath-like structure sized to interface with a stem of the thermometer while allowing a sensing tip of the thermometer to remain exposed for temperature sensing. The body is comprised of a through opening extending longitudinally along a central axis of the body. The through opening is dimensioned to receive the stem of the thermometer while allowing the sensing tip to extend beyond a distal portion of the body and remain exposed. The through opening allows insertion of the stem of the thermometer prior to a temperature measurement procedure. The through opening may be comprised of a retention feature configured to secure the body relative to the stem of the thermometer.

The body further comprises an impregnated flavoring. The flavoring may be incorporated within the material of the body or applied as a coating on a portion of the body. The flavoring releases a detectable taste when the body is placed within a patient's mouth during oral temperature measurement procedures using the thermometer. The flavoring provides sensory distraction that encourages correct placement of the thermometer and reduces discomfort or resistance associated with temperature measurement procedures. In one embodiment, the flavoring may be embedded within a raised indicia formed on a portion of the body. The raised indicia or the flavoring may be positioned along an exterior surface of the body that contacts oral tissues during placement of the device. The raised indicia or the body may further comprise a texture to retain the flavoring. The raised indicia or the texture may additionally provide tactile or visual distraction that encourages patient cooperation during temperature measurement procedures.

Accordingly, the flavored thermometer cover device of the present invention is particularly advantageous as it provides a device that functions as a sanitary barrier for a thermometer while simultaneously improving patient cooperation during oral temperature measurement procedures. More specifically, the flavored surface encourages children and other patients to keep the thermometer probe properly positioned under the tongue for a sufficient duration to obtain an accurate reading. The incorporated flavoring and raised indicia may further provide sensory distraction and engagement that reduces fear and resistance commonly associated with medical instruments. The structural configuration of the body and retention features securely interface with the thermometer while allowing the sensing tip to remain exposed for accurate temperature detection. Accordingly, the device improves the efficiency of temperature measurement procedures while enhancing comfort, hygiene, and patient cooperation in medical environments by overcoming the limitations of existing temperature devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a flavored thermometer cover device of the present invention in accordance with the disclosed architecture; and

FIG. 2 illustrates a top view of one potential embodiment of a flavored thermometer cover device of the present invention while attached to a thermometer in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that encourages children and other patients to keep a thermometer probe under the tongue long enough to obtain an accurate body temperature reading. There also exists a long-felt need in the art for a flavored thermometer cover device that releases a pleasant flavor upon contact with saliva to provide sensory distraction during temperature measurement procedures. Moreover, there exists a long-felt need in the art for a flavored thermometer cover device that maintains a sanitary barrier between a thermometer and a patient while improving patient comfort and cooperation.

The present invention, in one exemplary embodiment, is comprised of a flavored thermometer cover device. The device is a disposable cover designed to support temperature measurement procedures while improving patient comfort and cooperation. In particular, the device interfaces with a thermometer during oral temperature measurement and incorporates a flavoring that produces sensory distraction during the procedure. The flavoring encourages proper placement of the thermometer and helps reduce patient resistance during temperature measurement.

The device is comprised of a body formed from a medical-grade material. The body is configured as a tubular or sheath-like structure sized to engage a stem of the thermometer while allowing a sensing tip of the thermometer to remain exposed for temperature detection. The body further comprises a through opening extending longitudinally along a central axis of the body. The through opening is dimensioned to receive the stem of the thermometer so that the sensing tip extends beyond a distal portion of the body and remains exposed. The through opening permits insertion of the stem of the thermometer prior to performing a temperature measurement procedure. The through opening may further comprise a retention feature configured to secure the body relative to the stem of the thermometer.

The body further comprises an impregnated flavoring. The flavoring may be incorporated within the material of the body or applied as a coating on a portion of the body. When the body is positioned within a patient's mouth during oral temperature measurement procedures using the thermometer, the flavoring releases a detectable taste. The flavoring produces sensory distraction that promotes correct positioning of the thermometer and reduces discomfort or resistance associated with temperature measurement procedures. In one embodiment, the flavoring may be embedded within a raised indicia formed on a portion of the body. The raised indicia or the flavoring may be positioned along an exterior surface of the body that contacts oral tissues during placement of the device. The raised indicia or the body may further comprise a texture that retains the flavoring. The raised indicia or the texture may also provide tactile or visual distraction that promotes patient cooperation during temperature measurement procedures.

As such, the device provides a sanitary barrier for a thermometer while simultaneously improving patient cooperation during oral temperature measurement procedures. The flavored surface further encourages children and other patients to maintain the thermometer probe in a proper position beneath the tongue for a sufficient duration to obtain an accurate reading. The incorporated flavoring and raised indicia further provide sensory distraction and engagement that reduce fear and resistance commonly associated with medical instruments. The structural configuration of the body and associated retention features securely engage the thermometer while allowing the sensing tip to remain exposed for accurate temperature detection. Therefore, the device improves the efficiency of temperature measurement procedures while enhancing comfort, hygiene, and patient cooperation in medical environments.

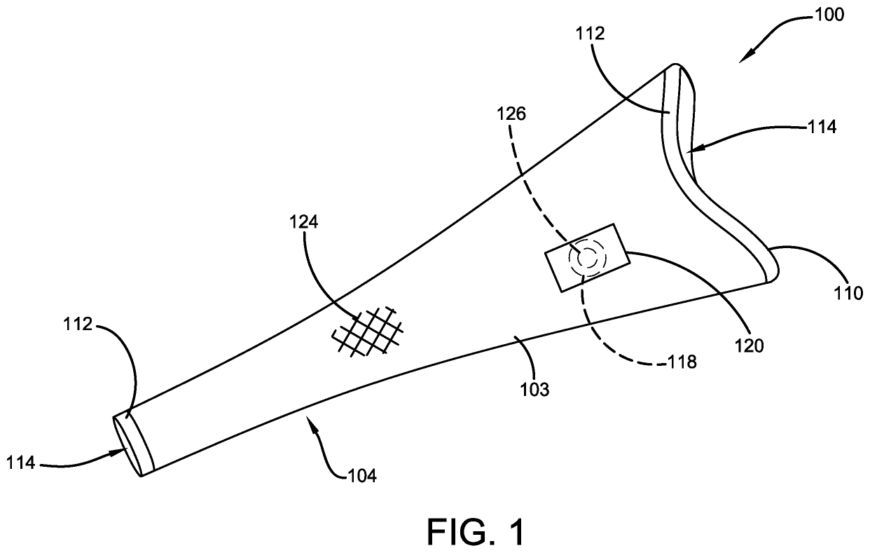

Referring initially to the drawings, FIG. 1 illustrates a perspective view of one potential embodiment of a flavored thermometer cover device 100 of the present invention in accordance with the disclosed architecture. The device 100 is a disposable cover configured to facilitate temperature measurement procedures while improving patient cooperation and comfort during the same. More specifically, the device 100 may be configured to interface with a thermometer 102 during oral temperature measurement procedures while maintaining a sanitary barrier between the thermometer 102 and a patient. The device 100 may further be configured to provide sensory distraction during temperature measurement procedures through incorporation of a flavoring 118 associated with the device 100, thereby encouraging proper thermometer 102 placement and reducing patient resistance that may otherwise occur during temperature measurement procedures. The device 100 may therefore function both as a hygienic protective cover for the thermometer 102 and as a patient-engagement feature that may improve cooperation during medical assessment procedures.

The device 100 is comprised of a body 104 made from a medical-grade material such as but not limited to medical-grade polymer, polyethylene, polypropylene, silicone-based elastomer, thermoplastic elastomer, biodegradable polymer film, laminated medical barrier material, multilayer polymer film, antimicrobial polymer composite, etc. The body 104 may be configured as a generally tubular or sheath-like structure sized to interface with the stem 106 of the thermometer 102 while allowing the sensing tip 108 of the thermometer 102 to remain exposed for direct temperature sensing. In one embodiment, the body 104 may be made from a flexible material. In another embodiment, the body 104 may be made from a semi-rigid or rigid material.

The body 104 may be comprised of a through opening 110 extending longitudinally through the body 104, as seen in FIG. 1. The through opening 110 may extend substantially along a central longitudinal axis of the body 104 and may be dimensioned to receive the stem 106 of the thermometer 102 such that the sensing tip 108 of the thermometer 102 extends beyond a distal portion of the body 104 and remains exposed. The through opening 110 may allow the stem 106 of the thermometer 102 to be inserted into the body 104 prior to a temperature measurement procedure performed by the thermometer 102. In certain embodiments, the internal diameter of the through opening 110 may be shaped and configured to provide a close sliding engagement with the stem 106 of the thermometer 102 in order to maintain alignment of the body 104 relative to the thermometer 102.

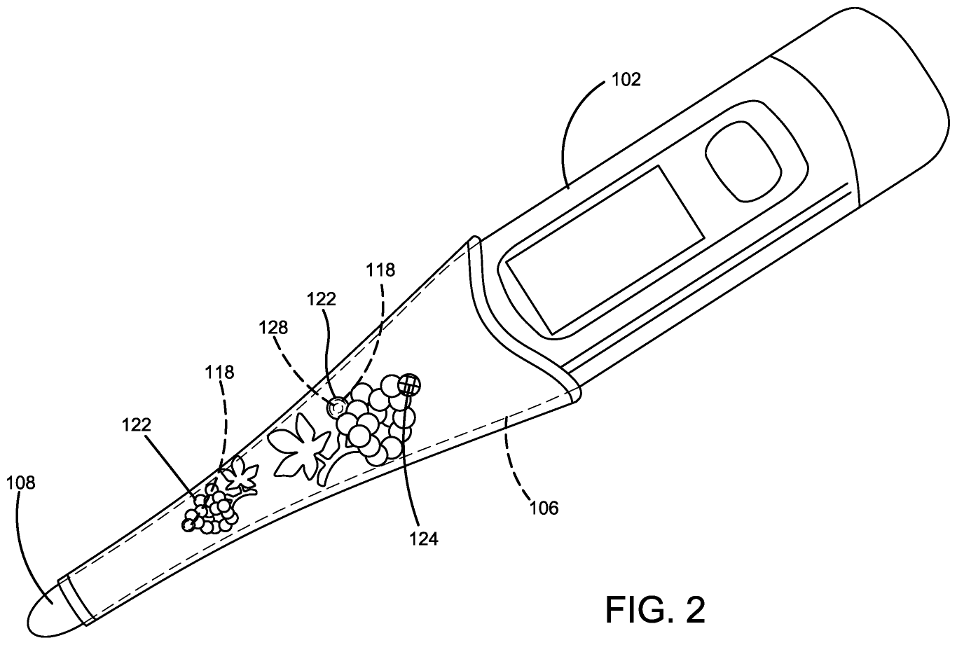

In one embodiment, the through opening 110 may be comprised of a retention feature 112 configured to help secure the body 104 relative to the stem 106 of the thermometer 10,2, as seen in FIGS. 1-2. The retention feature 112 may be comprised of a flexible lip configured to elastically deform during insertion of the stem 106 of the thermometer 102 and may return toward an original position once the stem 106 of the thermometer 102 is positioned within the body 104. In certain embodiments, the retention feature 112 may extend circumferentially around a first end 114 and/or second end 116 of the opening 110 in order to produce a uniform retention force relative to the stem 106 of the thermometer 102. In additional embodiments, the retention feature 112 may be comprised of structures such as but not limited to elastic collars, compressible rings, friction ribs, inward protrusions, textured gripping surfaces, sealing ridges, inwardly tapered sections, resilient constriction zones, etc.

The body 104 may further be comprised of an impregnated flavoring 118, as seen in FIGS. 1-2. The flavoring 118 may be incorporated within the material of the body 104 or applied as a coating 120 on a portion of the body 104. The flavoring 118 may be configured to release a detectable taste when the body 104 is placed within a patient's mouth during oral temperature measurement procedures using the thermometer 102, wherein the flavoring 118 may provide a sensory distraction that may encourage correct placement of the thermometer 102 and may reduce discomfort or resistance often associated with temperature measurement procedures, particularly in pediatric or emergency care environments.

In one embodiment, the flavoring 118 may be embedded within an indicia 122 formed on a portion of the body 104, as seen in FIG. 2, wherein the indicia 122 may be 2-dimensional or 3-dimensional. The indicia 122 may be in the form of a raised shape, symbol, character, icon, pattern, logo, texture, or decorative structure. In certain embodiments, the indicia 122 and/or flavoring 118 may be positioned along an exterior surface 103 of the body 104 that is likely to contact the tongue or oral tissues during placement of the device 100 within the mouth. In some embodiments, the indicia 122 or the body 104 may be comprised of a texture 124 such as surface recesses, micro-textures, or patterned surfaces that may assist in retaining the flavoring 118 on the body 104. The raised indicia 122 and/or texture 124 may also provide a tactile or visual feature that may further distract or comfort a patient during temperature measurement procedures performed using the thermometer 102 and the device 100. The raised indicia 122 may also be configured in playful or recognizable shapes that may encourage patient cooperation during temperature measurement procedures.

The flavoring 118 utilized within the body 104 may be comprised of a wide variety of flavoring formulations such as but not limited to honey flavoring, bubblegum flavoring, grape flavoring, pineapple flavoring, strawberry flavoring, watermelon flavoring, mint flavoring, citrus flavoring, vanilla flavoring, chocolate flavoring, etc. The flavoring 118 may be sweetened flavoring formulations or sugarless flavoring formulations depending on desired patient compatibility. Sweetened versions of the flavoring 118 may utilize sweetening compounds 126 such as but not limited to sucrose, glucose derivatives, stevia extracts, agave extracts, natural sweetening compounds, etc. Sugarless versions of the flavoring 118 may utilize sweetening agents 128 such as but not limited to xylitol, sorbitol, erythritol, sucralose, monk fruit extract, other non-caloric sweetening compounds, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flavored thermometer cover device” and “device” are interchangeable and refer to the flavored thermometer cover device 100 of the present invention.

Notwithstanding the foregoing, the flavored thermometer cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the flavored thermometer cover device 100 as shown in the FIGS. are for illustrative purposes only, and that many other sizes and shapes of the flavored thermometer cover device 100 are well within the scope of the present disclosure. Although the dimensions of the flavored thermometer cover device 100 are important design parameters for user convenience, the flavored thermometer cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flavored thermometer cover device comprising:
a body;
a through opening extending longitudinally through the body; and
a flavoring applied or impregnated into the body, wherein the flavoring is configured to release a detectable taste.

2. The flavored thermometer cover device of claim 1, wherein the body is a flexible material.

3. The flavored thermometer cover device of claim 1, wherein the flavoring is present as a coating on the body.

4. The flavored thermometer cover device of claim 1, wherein the body is comprised of a raised indicia.

5. The flavored thermometer cover device of claim 4, wherein the flavoring is impregnated within the raised indicia.

6. The flavored thermometer cover device of claim 4, wherein the raised indicia or the body is comprised of a texture.

7. The flavored thermometer cover device of claim 4, wherein the flavoring is comprised of a sweetening compound.

8. The flavored thermometer cover device of claim 4, wherein the flavoring is comprised of a sweetening agent.

9. A flavored thermometer cover device comprising:
a body;
a through opening extending longitudinally through the body;
a first retention fastener positioned on a first end of the through opening; and
a flavoring applied or impregnated into the body, wherein the flavoring is configured to release a detectable taste.

10. The flavored thermometer cover device of claim 9, wherein the body is comprised of a raised indicia.

11. The flavored thermometer cover device of claim 10, wherein the flavor is impregnated within the raised indicia.

12. The flavored thermometer cover device of claim 10, wherein the raised indicia or the body is comprised of a texture.

13. The flavored thermometer cover device of claim 9, wherein the flavoring is comprised of a sweetening compound.

14. The flavored thermometer cover device of claim 9, wherein the flavoring is comprised of a sweetening agent.

15. A flavored thermometer cover device comprising:
a body;
a through opening extending longitudinally through the body;
a first retention fastener positioned on a first end of the through opening;
a second retention fastener positioned on a second end of the through opening; and
a flavoring applied or impregnated into the body, wherein the flavoring is configured to release a detectable taste.

16. The flavored thermometer cover device of claim 15, wherein the body is comprised of a raised indicia.

17. The flavored thermometer cover device of claim 16, wherein the flavor is impregnated within the raised indicia.

18. The flavored thermometer cover device of claim 16, wherein the raised indicia or the body is comprised of a texture.

19. The flavored thermometer cover device of claim 15, wherein the flavoring is comprised of a sweetening compound.

20. The flavored thermometer cover device of claim 15, wherein the flavoring is comprised of a sweetening agent.
